(19) United States
(12) Patent Application Publication
(10) Pub. No.: US 2011/0305845 A1
(43) Pub. Date: Dec. 15, 2011

(54) Manufacture Method of Decorative Zipper

(75) Inventor: Shiu Ming Leung, Guangdong (CN)

(73) Assignee: JIANGMEN M.F.B.S. MACHINERY LTD., Jiangmen City, Guangdong (CN)

(21) Appl. No.: 13/203,021

(22) PCT Filed: Oct. 23, 2010
(86) PCT No.: PCT/CN10/78048

§ 371 Date: Aug. 24, 2011

(30) Foreign Application Priority Data
Feb. 9, 2010 (CN) 201010301401.2

(51) Int. Cl. B05D 5/06; B05D 1/16; B05D 3/00; B05D 5/00

(52) U.S. Cl. 427/462; 427/256; 427/157; 427/180

(57) ABSTRACT

The present invention discloses a decorative zip manufacturing method, which comprises the steps of: melting and coating the thermoplastic resin on the surface of at least one side of the zip ribbon to gain a zip with a thermoplastic resin layer; melting the thermoplastic resin layer and fixing a functional material on the thermoplastic resin layer melted; cutting the functional layer and the thermoplastic resin layer among the center line of the zip teeth. The zip manufactured according to the present invention is featured in the strong adhesive force between the thermoplastic layer and the zip ribbon, and a longer service life; a number of conventional approaches could be used to composite a variety of materials and the thermoplastic resin layer together, providing conveniences for producing all kinds of decorative zips, so as to satisfy the pursuit of personalization of people, in particular of the young people.

### TECHNICAL FIELD

The present invention relates to a zip manufacturing method, and more particularly to a multi-layer decorative zip manufacturing method.

### BACKGROUND INFORMATION

As easy to use, a huge number of zips have been used. However the function of zips has not been changed for a long time, they always look fusty, most of them only have a single color, bad in decoration, cannot satisfy the pursuit of personalization of people, in particular of the young people.

The current multi-layer zips are mainly the water-proof zips; a common manufacturing method for them comprises the steps of: combining the water-proof layer of high fusion point and the thermoplastic resin layer of low fusion point together to form a composite membrane, and then pasting and fixing the composite membrane on the zip ribbon. The adhesive force between the functional layer and the zip ribbon according to this method is weak. Usually after a long time use, the thermoplastic resin layer will partially even entirely peel off; this not only makes the zip lose its original functions, but also impacts the appearance of the zip.

In addition, the water-proof zip manufacturing method described above also has great limitations, for example, as in manufacturing, the thermoplastic resin layer and water-proof layer must be produced in a form of membrane before forming the composite membrane, resulting from this, many decorative materials, such as glitter powders and fluffs, are hard to be used to compose the membranes, the final products lack decorativeness. Furthermore, some other types of zips, such as the decorative zips which become more prevalent, are difficult to be produced based on the water-proof zip manufacturing method described above, according to needs.

### THE SUMMARY OF THE INVENTION

In order solve the problems above, the present invention provides a new-type manufacturing method for decorative zips.

The technical scheme adopted by the present invention is:

A decorative zip manufacturing method, comprising the steps of:

1) heating a thermoplastic resin to melt, and fixing the thermoplastic resin melted on the surface of at least one side of a zip, to obtain a zip with a thermoplastic resin layer;

2) heating the thermoplastic resin layer to melt, and fixing a decorative material on the thermoplastic resin layer melted to form a decorative layer;

3) after cooling, cutting the decorative layer and the thermoplastic resin layer among the central line of the zip teeth.

Preferably, for better fixation, the thermoplastic resin is fixed on the surface of at least one side of the zip ribbon through pressing, and further diffused into the fiber of the zip ribbon by suction, thus the thermoplastic resin could penetrate in the fiber of the zip ribbon more deeply.

Preferably, preheating the zip ribbon before compositing it with the thermoplastic resin layer, to extend the cooling time of the thermoplastic resin in the zip ribbon, the liquid thermoplastic resin and the fiber of the zip ribbon will thus be tied together more closely.

The advantages of the present invention could be:

In the zip manufactured according to the present invention, the adhesive force between the thermoplastic resin layer and the zip ribbon is strong; the zip is thus more reliable and durable. A variety of decorative materials could be cooperated with the thermoplastic resin layer according to needs. Many conventional methods, such as coating, pressing, embossing, spraying, electrostatic flocking, and heat transfer and so on, could be used to satisfy all kinds of clients, in particular to satisfy the pursuit of personalization of the young people.

### THE DESCRIPTION OF THE EMBODIMENTS

The invention will be further described on the basis of the preferred embodiments.

### The First Embodiment:

1. pre-heating the thermoplastic resin and zip ribbon;

2. heating the thermoplastic resin to melt into liquid, keeping it in the liquid state, and then coating it on the surface of one side of the zip ribbon, meanwhile on the other side of the zip ribbon using an air extractor to suck out the air to make the thermoplastic resin melted diffuse into the fiber of the zip ribbon, to obtain a zip with a thermoplastic resin layer;

3. melting the thermoplastic resin layer, and fixing a colorful fabric as the decorative material on the thermoplastic resin layer melted;

4. after cooling, cutting the decorative material layer of the colorful fabric and the thermoplastic resin layer along the center line of the zip teeth, to obtain a colorful fabric zip.

### The Second Embodiment

1. preheating the thermoplastic resin and zip ribbon;

2. heating the thermoplastic resin to melt into liquid, keeping it in the liquid state, and then coating it on the surface of one side of the zip ribbon, meanwhile on the other side of the zip ribbon using an air extractor to suck out the air to make the thermoplastic resin melted diffuse into the fiber of the zip ribbon, to obtain a zip with a thermoplastic resin layer;

3. melting the thermoplastic resin layer, and fixing glitter powder as the decorative material on the thermoplastic resin layer melted;

4. after cooling, cutting the decorative material layer of glitter powder and the thermoplastic resin layer along the center line of the zip teeth, to obtain a glitter zip.

### The Third Embodiment:

1. preheating the thermoplastic resin and zip ribbon;

2. heating the thermoplastic resin to melt into liquid, keeping it in the liquid state, and then coating it on the surface of one side of the zip ribbon, meanwhile on the other side of the zip ribbon using an air extractor to suck out the air to make the thermoplastic resin melted diffuse into the fiber of the zip ribbon, to obtain a zip with a thermoplastic resin layer;

3. melting the thermoplastic resin layer, and fixing flocks as the decorative material on the thermoplastic resin layer melted by electrostatic flocking;

4. after cooling, cutting the decorative material layer of flocks and the thermoplastic resin layer along the center line of the zip teeth, to obtain a colorful flock zip.

### The Fourth Embodiment:

1. preheating the thermoplastic resin and zip ribbon;

2. heating the thermoplastic resin to melt into liquid, keeping it in the liquid state, and then coating it on the surface of one side of the zip ribbon, meanwhile on the other side of the zip ribbon using an air extractor to suck out the air to make the thermoplastic resin melted diffuse into the fiber of the zip ribbon, to obtain a zip with a thermoplastic resin layer;

3. melting the thermoplastic resin layer, and pressing and fixing reflective glass beads as the decorative material on the thermoplastic resin layer melted;

4. after cooling, cutting the decorative material layer of reflective glass beads and the thermoplastic resin layer along the center line of the zip teeth, to obtain a reflective zip.

### The Fifth Embodiment:

1. preheating the thermoplastic resin and the zip ribbon;

2. heating the thermoplastic resin to melt into liquid, keeping it in the liquid state, and then coating it on the surface of one side of the zip ribbon, meanwhile on the other side of the zip ribbon using an air extractor to suck out the air to make the thermoplastic resin melted diffuse into the fiber of the zip ribbon, to obtain a zip with a thermoplastic resin layer;

3. melting the thermoplastic resin layer, and pressing and fixing the decorative material with printed patterns on the thermoplastic resin layer melted;

4. after cooling, cutting the decorative material layer and the thermoplastic resin layer among the center line of the zip teeth, to obtain a zip with printed patterns.

### The Sixth Embodiment:

1. preheating the thermoplastic resin and the zip ribbon;

2. heating the thermoplastic resin to melt into liquid, keeping it in the liquid state, and then coating it on the surface of one side of the zip ribbon, meanwhile on the other side of the zip ribbon using an air extractor to suck out the air to make the thermoplastic resin melted diffuse into the fiber of the zip ribbon, to obtain a zip with a thermoplastic resin layer;

3. melting the thermoplastic resin layer, and fixing the fluorescent decorative material on the thermoplastic resin layer melted by pressing;

4. after cooling, cutting the fluorescent decorative material layer and the thermoplastic resin layer among the center line of the zip teeth, to gain a fluorescent zip.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structure.

1. A decorative zip manufacturing method, comprising the following steps:
1) heating a thermoplastic resin to melt, and fixing the thermoplastic resin melted on the surface of at least one side of a zip, to obtain a zip with a thermoplastic resin layer;
2) heating the thermoplastic resin layer to melt, and fixing a decorative material on the thermoplastic resin layer melted to form a decorative layer;
3) after cooling, cutting the decorative layer and the thermoplastic resin layer among the central line of the zip teeth.

2. The decorative zip manufacturing method according to claim 1, wherein the thermoplastic resin layer are fixed on the surface of at least one side of the zip by heat treatment coating.

3. The decorative zip manufacturing method according to claim 1, wherein in the step 1 the thermoplastic resin melted is diffused into the fiber of the zip ribbon by suction.

4. The decorative zip manufacturing method according to claim 1, wherein in the step 1 and 2, the thermoplastic resin is preheated before being melted.

5. The decorative zip manufacturing method according to claim 1, wherein the zip is preheated before being composited with the thermoplastic resin.

6. The decorative zip manufacturing method according to claim 1, wherein the approaches for fixing the decorative material on the thermoplastic resin layer may include coating, pressing, spraying, electrostatic flocking, and heat transfer.

7. The decorative zip manufacturing method according to claim 1, wherein the decorative materials may include fluorescence materials, reflective materials, glitter powders, colorful flocks, heat transfer printing materials, pattern printing materials or embossing pattern materials.
